(19) United States
(12) Patent Application Publication
(10) Pub. No.: US 2014/0125218 A1
(43) Pub. Date: May 8, 2014

(54) Luminaire Comprising A Fluorescent Light Bulb, Mercury Sorbent, And Secondary Covering

(71) Applicant: James Scott Hacsi, Pueblo, CO (US)

(72) Inventor: James Scott Hacsi, Pueblo, CO (US)

(21) Appl. No.: 14/064,151

(22) Filed: Oct. 27, 2013

Related U.S. Application Data
(60) Provisional application No. 61/722,484, filed on Nov. 5, 2012.

(51) Int. Cl. H01J 5/12; H01J 9/24

(52) U.S. Cl. CPC H01J 5/125; H01J 9/245
USPC 313/493; 445/58

(57) ABSTRACT

A luminaire comprising a fluorescent light bulb, mercury sorbent, and a secondary covering is presented along with methods for making and using a luminaire that has mercury sorbent placed under a secondary transparent or translucent covering, coating, or skin and over the glass-casing of the fluorescent light bulb comprising the luminaire so that elemental mercury will not escape to the environment surrounding the luminaire if and when the glass-casing of the fluorescent light bulb ever breaks or ruptures.

### CROSS-REFERENCE TO RELATED APPLICATIONS

This application claims the benefit of U.S. Provisional Application 61/722,484, filed 2012-05-11

### STATEMENT REGARDING SPONSORED RESEARCH

Not applicable

### SEQUENCE LISTING OR PROGRAM

Not applicable

### BACKGROUND OF THE INVENTION

1. Field of the Invention

This invention relates generally to lighting fixtures or luminaires and methods of making and using them, and more specifically, this invention relates to an eco-friendly luminaire comprised of a fluorescent light bulb that contains mercury, mercury sorbent matter, and a permanently-affixed transparent or translucent secondary covering, as well as methods of making and using said luminaire.

2. Description of the Prior Art

Fluorescent light bulbs, either Compact Fluorescent Lamps (CFLs) or tubular types, contain small amounts of mercury mostly in its elemental form which is a neurotoxin that's extremely dangerous to pregnant women and infants. Relatively few fluorescent light bulbs are re-cycled for use and that means hundreds of millions of them eventually end up in community landfills where the mercury can leak from the ruptured bulbs and contaminate ground water or the surrounding soil. The bulbs are also dangerous to workers that collect and transport garbage containing broken fluorescent light bulbs along with their mercury contents. A fluorescent light bulb for the purposes of this application is comprised of a glass-casing that contains electrodes, mercury, a gas (other than air), and a phosphor-coating residing on the inside surface of the glass shell. A “luminaire” in this case refers to a lighting fixture that contains a fluorescent light bulb along with other components, such as a protective covering or coating on or over the glass-casing of the fluorescent lamp (a fluorescent light bulb and a fluorescent lamp are understood to mean the same thing in this specification). Needless to say, the glass-casing of a fluorescent lamp is very prone to breakage and in that case, mercury and its vapors can escape the broken or ruptured glass-casing and contaminate the surrounding environment. The amount of mercury in fluorescent light bulbs (lamps) is constantly being reduced and it negatively affects the operation and operating life of the bulbs. Thus, if there were a way to render the mercury inside fluorescent light bulbs harmless so it doesn't adversely affect its surroundings in case the glass shell is ever broken, then the US Government may allow manufacturers to add more mercury to each fluorescent light bulb. With more mercury inside them, the life of the fluorescent bulbs will be increased and so will the quality of light they emit. There are inventions found in the prior art that relate to fluorescent light bulbs having protective coverings, such as plastic tubes or glass bulb-shaped casings, so the bulb fits standard lamp designs or common lamp-shade configurations (so the glass housing looks and fits like the glass housing of a standard incandescent light bulb), that fit over or onto the glass housing of the bulb in order to prevent contamination of the surrounding environment from components of the broken bulb, such as glass shards in case the bulb's glass housing breaks. The protective coating or covering does little to stop mercury from eventually escaping to the surrounding environment if the glass-casing of the bulb is ever broken. One company, Shat-R-Shield Inc., has been adding shatterproof plastic coatings that are applied directly onto the glass housings of fluorescent light bulbs for over 30 years. The problem with protective coverings and coatings for fluorescent lights as found in the prior art is that they will surely break open and rupture when subjected to the harsh conditions of a trash landfill. When that happens, mercury—a deadly neurotoxin—will leak from discarded broken fluorescent bulbs and into the environment surrounding the landfill. Relatively small amounts of mercury can contaminate large quantities of groundwater below the landfill rendering it unsafe for human consumption. Notice specifically that none of the inventors, producers, or manufacturers of the protective coverings or coatings applied to fluorescent light bulbs mention, suggest, or disclose the addition of a mercury sorbent to a luminaire comprised of a fluorescent light bulb (lamp) that contains mercury inside for the purpose of neutralizing mercury as it escapes from the bulb's glass housing.

Researchers at Brown University discovered that a variant of a substance called nanoselenium (nano-Se) can absorb most of the mercury emitted from broken and spent fluorescent lights, including compact fluorescent lamps (CFLs). Brown University and its researchers have commercialized two products related to their nano-Se discovery. One product is a mercury absorbent lining in store-bought CFL packages which is a three-layered cloth attached to the inside package/box that holds the CFL. The coated nanoselenium layer is inside the package between cardboard and cloth so that the nano-Se compound is not exposed to users. The second product involves plastic bags with mercury-absorbent linings where a fluorescent light bulb can be placed into, and if broken, the mercury-absorbing lining of the bag would absorb mercury and prevent the vapors from escaping. And the objective of both products is to alleviate the harm that can be done to humans and the environment when mercury escapes from a broken or ruptured fluorescent light bulb of any type (that contains mercury). U.S. Pat. Nos. 8,506,923 (Hurt, et al., Aug. 13, 2013) and 8,491,865 (Hurt, et al., Jul. 23, 2013) known herein as the “Hurt” patents, disclose unstabilized selenium nanoparticles—a mercury sorbent—that's added to the base of a compact fluorescent lamp (CFL). However, the mercury sorbent, or nanoselenium (nano-Se) in those cases, is not contained between a protective outer covering or coating and the glass-casing of the Compact Fluorescent Lamp (CFL) so that if the glass-casing of the fluorescent lamp ever breaks or ruptures, there is nothing to ensure the escaping mercury vapor will be contained temporarily so it's directed to interact with the nano-Se mercury sorbent such that a different chemical compound is formed that is less harmful to the surrounding environment. Note also that the Hurt patents are specific in that they disclose only nanoselenium as a mercury sorbent used in various applications even though there are many other mercury sorbents that will work in those same applications.

Due to their obvious high conversion efficiency, there is no doubt the use of fluorescent lights with dangerous mercury inside will grow in the near future. A luminaire and methods of manufacturing and using a luminaire comprising a fluorescent lamp with mercury, a mercury sorbent, and a protective outer covering or coating are needed to overcome the disadvantages of the prior art so if the glass-casing of the fluorescent lamp ever breaks or ruptures, the mercury will chemically combine with the mercury sorbent inside the outer covering or coating in order to render it harmless to the surrounding environment. The inclusion of mercury-absorbing matter in a pad, rag, or bag that cleans up mercury that has already escaped from a broken fluorescent light bulb is simply not very effective and it's best to have the mercury-absorbing matter included somewhere on or in the physical structure of the luminaire itself. Some U.S. Pat. Nos., such as 7,410,054 (Shatford), 7,673,746 (Stone et al.), and 7,631,758 (Stennes) as well as various US patent applications, such as 11/525,449 (Kelly) and 12/249,796 (Maggio with 61/082,047 and 60/979,675 provisional applications referenced) all refer in some way and disclose methods, compositions, and devices for safe storage, transport, disposal and recycling of mercury-containing light bulbs or apparatuses. However, the ‘containers’ as disclosed in those prior art references are meant to be used before or after the light bulb is placed in service to provide light to an area, which means the containers must be taken off the bulbs and stored separately while the light bulb is being used to provide light. What is needed then is a luminaire with a translucent or transparent covering or coating that's permanently affixed on or over the glass-casing of the fluorescent lamp comprising the luminaire. In other words, there is no need to remove the covering or coating and store it elsewhere to be lost while the fluorescent lamp comprising the luminaire is producing visible light.

### OBJECTS AND ADVANTAGES

An object of the present invention is to overcome the disadvantages inherent in the prior art related to mercury contamination of the environment by providing a luminaire comprising a fluorescent lamp that contains mercury and which also has a mercury sorbent residing inside a transparent or translucent secondary covering or coating so that when the glass-casing of the fluorescent light bulb is broken or ruptured, mercury will not escape to the surrounding environment. Instead, mercury escaping from the broken glass-casing of the fluorescent light bulb will be held temporarily by the secondary covering, coating, or skin so it fully reacts and chemically combines with the mercury sorbent to make a new chemical compound that is less harmful to humans and the surrounding environment. Another object of the present invention is to provide a luminaire comprising a fluorescent light bulb with mercury inside a glass-casing, mercury sorbent, and a secondary transparent or translucent covering, coating, or skin that is permanently-affixed onto or over the glass-casing of the fluorescent light bulb so the covering or coating remains on the glass-casing while the light bulb is producing light, and so the covering or coating does not have to ever be stored separately from the luminaire. In words, the coating, covering, or skin that fits over the glass-casing of the light bulb stays permanently-affixed at all times in order to overcome a problem with prior art fluorescent light bulb coverings and containers in that it cannot be lost or separated from the fluorescent light bulb while the light bulb is in use providing light. Note that there may or may not be an air-gap between the glass-casing of the light bulb and the secondary covering or coating, respectively. A final object of the present invention is to provide methods of making and using a luminaire comprising a fluorescent light bulb that contains mercury, a mercury sorbent, and a protective outer covering or coating so that when the glass-casing of the fluorescent light bulb is broken or ruptured, mercury will not escape to the surrounding environment.

### Embodiments of the Present Invention

A preferred embodiment of the present invention is an eco-friendly luminaire comprising a fluorescent light bulb, mercury sorbent, and a secondary translucent or transparent covering, coating, or skin that fits on or over the glass-casing of the fluorescent light bulb. The mercury sorbent may be unstabilized amorphous selenium nanoparticles (nano-Se) or any other mercury sorbent that combines chemically with mercury to form a new compound. Other mercury sorbents considered for possible use in this embodiment of the present invention in order to reduce the cost of manufacturing include mercury sorbents such as carbon, sulfur, copper, nickel, zinc, silver, tungsten disulfide, or any other matter than will chemically react and combine with mercury to form a new chemical compound that's harmless to humans or the environment. The mercury sorbent is placed during manufacture between the unbroken glass-casing of the fluorescent light bulb and the shatterproof covering, coating, or skin which is comprised of glass, plastic, teflon, vinyl, or any other transparent or translucent matter. That way, the mercury sorbent will not react with the mercury inside the fluorescent light bulb until or unless the glass-casing of the fluorescent light bulb is broken or ruptured. Basically, the covering, coating, or skin will temporarily hold mercury escaping from the broken glass-casing of the fluorescent light bulb long enough for the mercury to fully chemically react with (combine) the mercury sorbent to produce a new compound that is less harmful to the surrounding environment. Note that the covering or coating does not necessarily have to be completely airtight or leak-proof as long as it stays intact long enough to allow the mercury sorbent inside to chemically react fully with mercury escaping from the broken or ruptured glass-casing of the fluorescent light bulb.

Another object of the present invention is to provide a method that overcomes the problem of mercury escaping from a broken or discarded fluorescent light bulb. The method, which is also an aspect of the present invention, comprises capturing mercury contained in a fluorescent light bulb, such as a tube-type fluorescent light bulb or a compact fluorescent lamp (CFL), before the mercury escapes or is released from the glass-casing of the light bulb to the surrounding environment when the glass-casing of the light bulb breaks or ruptures. That method specifically entails first providing a fluorescent lamp or light bulb that contains mercury, a protective outer covering, coating, or skin that is shatterproof, translucent, or transparent and which covers or encases the glass-casing of the fluorescent light bulb, and a mercury sorbent that resides between the covering or coating and the unbroken glass-casing of the fluorescent light bulb. The mercury-absorbing matter stays between the covering or coating and the glass-casing of the light bulb until the glass-casing breaks or ruptures. At that point, any mercury that escapes from the broken glass-casing of the bulb will react and chemically combine with the mercury sorbent inside the unbroken (or partially broken) covering or coating to form a new chemical compound that is relatively much less harmful to the surrounding environment. The unusable luminaire with its neutralized mercury is then safely disposed of or recycled.

A final object of the present invention is to provide a method of manufacturing an eco-friendly luminaire that overcomes the problem with the prior art that mercury can escape to the surrounding environment when the glass-casing of a fluorescent light bulb is broken or discarded. The method, which is also an aspect of the present invention, comprises manufacturing an eco-friendly luminaire that's comprised of first providing a fluorescent light bulb containing mercury, then adding a plastic transparent or translucent container or coating that fits over or on the glass housing of the light bulb, then adding mercury-absorbing matter so it resides between the unbroken glass housing of the light bulb and the container or coating that fits over and is encasing the unbroken glass-casing of the fluorescent light bulb.

### SUMMARY

A preferred embodiment of the present invention is presented which is an eco-friendly luminaire comprising a fluorescent light bulb or lamp, mercury sorbent, and a permanently-affixed (not to be removed) transparent, translucent, plastic, or glass secondary covering, coating, or skin that fits over, covers, or substantially encases the unbroken glass-casing of the fluorescent light bulb. A method is also provided for preventing mercury from escaping to the surrounding environment of a broken glass-casing of a fluorescent light bulb. That method comprises providing a luminaire comprised of a fluorescent lamp, mercury sorbent, and a secondary covering, then placing the mercury sorbent between the outside surface of the unbroken glass-casing of the fluorescent light bulb and the inside surface of the secondary covering, then allowing mercury sorbent to chemically react with mercury escaping from the glass-casing of the fluorescent light bulb when the glass-casing breaks or ruptures, then discarding or recycling the luminaire, so the mercury is transformed into a new chemical compound that is less harmful to humans and the environment. A method is also provided for manufacturing an eco-friendly luminaire. That method comprises providing a fluorescent light bulb that contains mercury, mercury sorbent, and a transparent or translucent covering, coating, or skin, then placing the mercury sorbent between the outside surface of the unbroken glass-casing of the fluorescent light bulb and the inside surface of the transparent or translucent covering or coating that covers or encases the unbroken glass-casing of the fluorescent light bulb during its normal operating life.

### DRAWINGS

### Reference Numerals

1. Mercury sorbent matter (mercury sorbent)
2. Translucent or transparent secondary covering, coating, or skin
3. Mercury liquid or vapor
4. Breakable glass-casing of a fluorescent light bulb, such as a Compact Fluorescent Lamp (CFL)
5. Lamp base of a fluorescent light bulb (lamp)

### DESCRIPTION OF DRAWINGS

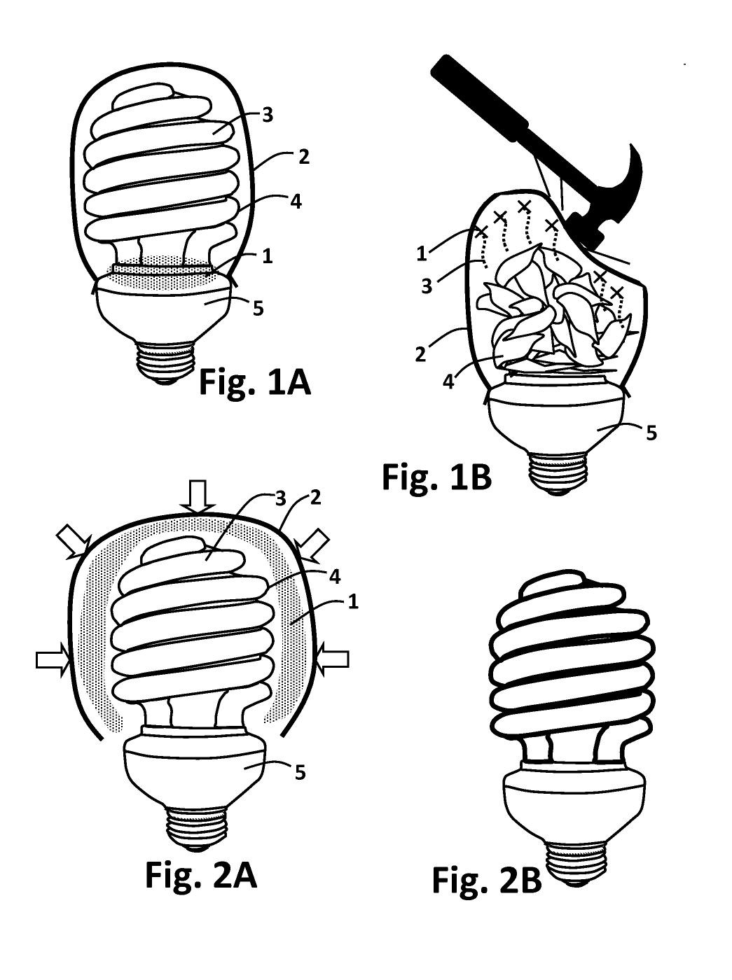

FIG. 1A shows a luminaire comprised of a fluorescent light bulb, such as a Compact Fluorescent Lamp (CFL), mercury sorbent, and a secondary coating, skin, or in this case a plastic or glass covering

FIG. 1B shows the same luminaire as depicted in FIG. 1A being destroyed by striking it with a hammer, which generally illustrates the method of the present invention comprising providing a luminaire comprised of a fluorescent light bulb, such as a Compact Fluorescent Lamp (CFL), mercury sorbent, and a coating, skin, or in this case a secondary plastic or glass covering, then storing the mercury sorbent between the secondary covering and the unbroken glass-casing of the CFL so the mercury does not combine with the mercury sorbent during normal operation of the CFL, then temporarily capturing mercury inside the substantially intact secondary covering so the mercury escaping from the broken glass-casing of the CFL (fluorescent light bulb) combines with the mercury sorbent also inside the secondary plastic or glass covering in order to form a new mercury compound that is less harmful than mercury to humans or the surrounding environment.

FIG. 2A shows the method of manufacturing a luminaire comprised of providing a fluorescent light bulb, mercury sorbent, and a secondary covering, coating, or in this case a plastic skin so the mercury sorbent is contained between the unbroken glass-casing of the fluorescent light bulb and the secondary coating, covering, or skin.

FIG. 2B shows the result after manufacturing a luminaire comprised of a fluorescent light bulb, mercury sorbent, and a secondary covering, coating, or in this case a plastic skin that tightly encases the unbroken glass-casing of the fluorescent light bulb or CFL (no air gap left between them) and holds the mercury sorbent between outside the unbroken glass-casing and the skin.

### DETAILED DESCRIPTION

FIG. 1A shows a first embodiment of the present invention which is a luminaire comprising a fluorescent light bulb, such as a Compact Fluorescent Lamp (CFL), mercury sorbent 1 that in this case resides near the bottom end of the unbroken glass-casing 4 of the fluorescent light bulb due to gravity, and a secondary glass or plastic covering 2 that holds the mercury sorbent 1 between the inside of the secondary covering 2 and outside the unbroken glass-casing 4 of the fluorescent light bulb (CFL). The fluorescent light bulb (CFL in this case) is comprised of a lamp base 5, a helical glass-casing or shell 4, and mercury vapor inside the glass-casing 3. Mercury vapor (and liquid) 3 inside the glass-casing of the CFL's glass-casing 4 and mercury sorbent 1 positioned outside of the glass casing of the CFL cannot physically interact or chemically combine together during normal operation of the CFL . Note there is an air-gap present in this embodiment of the present invention between the glass-casing of the fluorescent lamp and the secondary plastic or glass covering.

FIG. 1B shows the same fluorescent light bulb, which is a Compact Fluorescent Lamp (CFL), of FIG. 1A, which is an embodiment of the present invention, except a hammer has impacted and ruptured the glass-casing of the CFL, thus shattering it into many pieces. However, those glass pieces or shards are contained inside the un-ruptured, but now physically-distorted, permanently-affixed secondary plastic or glass covering 2. So a method of the present invention comprises first providing a luminaire comprised of a fluorescent light bulb, such as a Compact Fluorescent Lamp (CFL), mercury sorbent 1, and a secondary glass or plastic covering 2 that holds the mercury sorbent 1 between the inside surface of the secondary covering 2 and the outside surface of the unbroken glass-casing of the fluorescent light bulb (CFL), then capturing mercury escaping from the broken glass-casing of a fluorescent light bulb by temporarily containing the escaping mercury inside the permanently-affixed secondary plastic or glass covering so it chemically reacts with the mercury sorbent, then disposing of or recycling the luminaire when the fluorescent light bulb p is broken or stops operating. Basically, the method of the present invention allows mercury vapor 3 and the mercury sorbent 1 to fully react together inside the secondary covering to form a new chemical compound that is less harmful to humans and the environment before or after the luminaire is disposed of or whenever the glass-casing of the fluorescent light bulb breaks prematurely. Note that even though a CFL is shown in this depiction, any type or shape of fluorescent light bulb (linear, double-U, single-helix, double-helix, spiral, etc.) that contains mercury for its normal operation can be substituted for this description. Also, the translucent or transparent secondary covering is applied so it loosely encases the glass shell where an air gap is left between it and the glass-casing.

FIG. 2B generally illustrates the method of the present invention comprising the manufacture of a luminaire comprised of a fluorescent light bulb, such as a Compact Fluorescent Lamp (CFL), mercury sorbent 1, and a secondary glass or plastic covering 2 that holds the mercury sorbent 1 between the inside of the secondary covering 2 and outside the unbroken glass-casing of the fluorescent light bulb (CFL). Basically, the manufacturing method which is an aspect of the present invention comprises providing a fluorescent light bulb, such as a Compact Fluorescent Lamp (CFL), mercury sorbent 1, and a secondary glass or plastic covering, coating, or skin (coating or skin in this case) 2 that holds the mercury sorbent 1 between the inside of the secondary coating or skin 2 and outside the unbroken glass-casing of the fluorescent light bulb (CFL) In other words, the fluorescent light bulb is provided first, then the mercury sorbent is applied to the outside surface of the unbroken glass-casing of the fluorescent light bulb (CFL), then the secondary plastic or glass coating or skin is applied over the mercury sorbent to hold the sorbent in place. The coating or skin can be applied by several known application methods, which may include spraying it on or hot-dipping the unbroken glass-casing (with mercury sorbent applied to the outside surface) into a bath of molten plastic or glass with or without an electric charge applied. The mercury sorbent, which will most likely be in the form of tiny particles or a liquid chemical compound, may also be applied by spraying it on or by dipping the glass-casing into a batch of mercury sorbent powder or by dipping the glass-casing into a bath of liquid mercury sorbent.

FIG. 2B illustrates the end result of the method of manufacturing a luminaire comprised of a fluorescent light bulb, such as a Compact Fluorescent Lamp (CFL), mercury sorbent 1, and a secondary glass or plastic coating or skin 2 that holds the mercury sorbent 1 between the inside of the covering 2 and outside the unbroken glass-casing of the fluorescent lamp (CFL). The mercury sorbent is held between the inside surface of the secondary coating (or skin) and the outer surface of the unbroken glass-casing of the fluorescent light bulb (CFL in this case) until the glass-casing of the fluorescent light bulb breaks. Thus, any method of manufacturing that results in a luminaire comprised of a fluorescent light bulb, such as a Compact Fluorescent Lamp (CFL), mercury sorbent and a secondary glass or plastic covering, coating, or skin that holds the mercury sorbent between the inside of the secondary covering and outside the unbroken glass-casing of the fluorescent light bulb (CFL) will be known as the same method which is an aspect of, or the method comprising the present invention. Note that in the method of manufacture, which is known as an aspect of the present invention, it doesn't matter if an air-gap is left between the secondary covering and the glass-casing so the sorbent lies within that air-gap, or else whether the secondary coating or skin is applied directly to or so it conforms very closely to the outer contour of the unbroken glass-casing (a ‘skin’ or coating) and substantially encases the outside surface of the glass-casing of the fluorescent light bulb.

### Additional Embodiments

It should be obvious to one skilled in the art that the primary objective of the present invention is to manufacture and provide a luminaire comprising a fluorescent light bulb that contains mercury, mercury sorbent matter, and a permanently-affixed secondary covering, coating, or skin. Another objective of the present invention is to provide a method of making and using a luminaire comprising a fluorescent light bulb that contains mercury, mercury sorbent matter, and a permanently-affixed secondary covering, coating, or skin where the method of using the provided luminaire comprises providing mercury sorbent to the luminaire in a manner where the mercury sorbent does not chemically react and combine with the mercury contained inside the glass-casing of a fluorescent light bulb until and when the glass-casing of the fluorescent lamp breaks. When the glass-casing of the fluorescent lamp breaks, the mercury sorbent will chemically react with mercury escaping from the broken glass-casing of the fluorescent light bulb to form a new chemical compound that is less harmful than elemental mercury to humans and the surrounding environment. One skilled in the art will also recognize that a translucent or transparent covering, coating, or skin used to cover or coat the glass casing of the fluorescent light bulb (or apparatus for producing visible light) should be comprised of matter that is non-yellowing and which does not degrade physically in any way when exposed to ultraviolet radiation. And it should be further obvious to one skilled in the art that any reasonable embodiment of the means or methods described to accomplish the listed objectives of the present invention and which result in the same advantages will be seen as being the same intellectual entity as the present invention. Thus, the scope of this invention should be determined by any forthcoming claims and their legal equivalents, rather than by the examples given.

1. A luminaire, comprising:
a fluorescent light bulb comprised of a lamp base, glass-casing, mercury, electrodes, and an inert gas, and
mercury sorbent matter positioned outside of said glass-casing of said fluorescent light bulb, and
a secondary transparent or translucent covering, coating, or skin positioned to enclose and encase both said mercury sorbent matter and said glass-casing of said fluorescent light bulb,
whereby said mercury inside said glass-casing of said fluorescent light bulb cannot be absorbed by or chemically combine with said mercury sorbent matter inside said secondary transparent or translucent covering, coating, or skin until or unless said glass-casing of said fluorescent light bulb breaks or ruptures.

2. The luminaire of claim 1 wherein said fluorescent light bulb is a compact fluorescent lamp or any light-emitting apparatus containing mercury.

3. The luminaire of claim 1 wherein said mercury sorbent matter is comprised of carbon, sulfur, copper, nickel, zinc, silver, tungsten disulfide, selenium, or any other matter that will chemically react and combine with mercury to form a new chemical compound, whereby said mercury when combined in said new chemical compound is less harmful to humans or the environment than elemental mercury.

4. The luminaire of claim 1 wherein said transparent or translucent secondary covering, coating, or skin is comprised of matter that resists yellowing, fogging, or any other type of physical degrading effect to its composition or features caused when said matter is exposed to ultraviolet electromagnetic radiation emitted from said fluorescent light bulb.

5. The luminaire of claim 1 wherein said transparent or translucent secondary covering, coating, or skin is permanently-affixed to, cannot be removed from, or always remains covering said glass-casing of said fluorescent light bulb, whereby permanently-affixed said transparent or translucent secondary container, coating, or skin does not have to be removed and stored separately from said fluorescent light bulb when said fluorescent light bulb is in normal use providing visible light to an area.

6. A method for preventing elemental mercury from leaking to the environment surrounding a fluorescent light bulb, comprising:
providing a fluorescent light bulb comprised of a glass-casing and mercury, and
providing a permanently-affixed translucent or transparent secondary covering, coating, or skin that can encase, enclose, or substantially cover or coat said glass-casing of said fluorescent light bulb, and
providing mercury sorbent matter, then
placing said mercury sorbent matter over, around, or on the outside surface of said glass-casing of said fluorescent light bulb, then
placing said secondary covering, coating, or skin over, around, and enclosing both said mercury sorbent matter and said glass-casing of said fluorescent light bulb, then
retaining said mercury sorbent matter between said secondary covering, coating, or skin and outside of said glass-casing of said fluorescent light bulb, then
allowing said mercury sorbent matter to chemically react with said mercury escaping from said glass-casing of said fluorescent light bulb when said glass-casing of said fluorescent light bulb breaks or ruptures, then
disposing of or recycling said fluorescent light bulb, said covering, coating, or skin, and chemically combined said mercury and said mercury sorbent matter,
whereby environmentally unfriendly said mercury of said fluorescent light bulb does not leak to the surrounding environment when said glass-casing of said fluorescent light bulb breaks or ruptures.

7. A method of manufacturing a luminaire, comprising:
providing a fluorescent light bulb comprised of a glass-casing and mercury, and
providing a transparent or translucent secondary covering, coating, or skin, and
providing mercury sorbent matter, then
placing said mercury sorbent matter over or around the outside surface of said glass-casing of said fluorescent light bulb, then
placing said secondary transparent or translucent covering, coating, or skin over or around both said mercury sorbent matter and said glass-casing of said fluorescent light bulb so said mercury sorbent matter is retained and encased between said secondary translucent or transparent covering, coating, or skin and said glass-casing of said fluorescent light bulb,
whereby said mercury inside said glass-casing of said fluorescent light bulb cannot be absorbed by, or chemically combine with, said mercury sorbent matter outside said glass-casing of said fluorescent light bulb and inside said secondary translucent or transparent covering, coating, or skin until or unless said glass-casing of said fluorescent light bulb breaks or ruptures.
